(19) United States
(12) Patent Application Publication
(10) Pub. No.: US 2014/0152056 A1
(43) Pub. Date: Jun. 5, 2014

(54) HEATING DEVICE FOR BICYCLE SEATS

(71) Applicants: Mikael Harstad, Stockholm (SE); Hans Abrahamsson, Vellinge (SE)

(72) Inventors: Mikael Harstad, Stockholm (SE); Hans Abrahamsson, Vellinge (SE)

(73) Assignee: Wrump AB

(21) Appl. No.: 13/261,776

(22) PCT Filed: May 14, 2012
(86) PCT No.: PCT/SE2012/000071

§ 371 Date: Nov. 8, 2013

(30) Foreign Application Priority Data
May 12, 2011 (SE) 1130037-3

(51) Int. Cl. B60N 2/56; B62J 1/22; B62J 1/20

(52) U.S. Cl. CPC B60N 2/56; B62J 1/20; B62J 1/22
USPC 297/180.1

(57) ABSTRACT

A heating device suitable for attachment to a bicycle seat. The device comprises a heating cushion having a seating surface. Further, the device comprises a seat cover configured to hold the cushion on top of the seating surface of the bicycle seat. The cushion is provided with one or more recesses in its seating surface. Also, the seat cover comprises one or more portions of flexible sheet material configured to cover said one or more recesses such that one or more cavities are formed between the one or more portions of flexible sheet material and the cushion.

### TECHNICAL FIELD

The present invention relates to devices for providing a heated seating surface on bicycle seats.

### BACKGROUND

Bicycles are effective means of human transport and at the same time provides means of getting everyday exercise. However, many people experience that their bicycle seat provides an uncomfortable experience during winter time, since the seat is often cold due to surrounding cold air.

A known seat cover is disclosed in CN2521119Y. The seat cover has a built-in electrical heating wire connected to a battery via a cable.

A drawback of this seat cover is that it is expensive and requires batteries.

Another known seat cover, which is disclosed in JP2007196975A, solves this problem by a seat cover having a zipper for insertion of an exothermic heat source between the bicycle seat and the seat cover.

A drawback of this seat cover is that is quickly loses heat to surrounding air, which is a problem when doing many stops, such as in city traffic and by red light at crossings.

Thus, a device mitigating the above mentioned deficiencies would be beneficial.

### SUMMARY OF THE INVENTION

Hence, an object of the invention is to provide improved heating comfort during bicycle rides in cold climate.

These and other objects, which will appear from the following description, have now been achieved by a heating device according to the present invention. The device is suitable for attachment to a bicycle seat and comprises a heating cushion having a seating surface. Further, the device comprises a seat cover configured to hold the cushion on top of the seating surface of the bicycle seat. The cushion is provided with one or more recesses in its seating surface. Also, the seat cover comprises one or more portions of flexible sheet material configured to cover said one or more recesses such that one or more cavities are formed between the one or more portions of flexible sheet material and the cushion.

When a bicycle rider is to go for a bike ride in a cold climate and wants to get some extra heat on the bicycle seat he/she just warms up the cushion in advance by use of any customary source of heat, for example by putting it in a microwave oven, standard oven or by any other means of heating.

In this way, when the temperature of the heated cushion is higher than body temperature of the person riding the bike, the cushion functions as a source of heat, effectively providing a heated seating surface for the bicycle rider to sit on.

The cavities between the seat cover and the cushion provide a means for insulation between the cushion and the flexible sheet material of the seat cover and thereby lowers the amount of direct heat conduction between the cushion and the seat cover, and thus also between the cushion and atmosphere surrounding the device. Hence, loss of heat from the cushion to surrounding air is mitigated, wherein the device according to the invention can sustain its heating abilities for a longer time when nobody is seated on the device, as compared to prior art devices.

At the same time, since the sheet material is flexible, the sheet material is temporarily brought in contact with the cushion when a person sits down on the seat cover. Then, as soon as the person leaves the seat, the sheet material retracts back towards its original position over said recesses, at least partly due to the inherent stiffness of the sheet material. In this way, efficient heat transfer between the cushion and a person riding the bike is maintained while the rider is seated, whilst at the same time insulation between the cushion and surrounding atmosphere is improved, such that the heating functionality of the heating device is available for a longer time.

In an embodiment, the flexible sheet material is elastic. This brings a further advantage in that the sheet material adapts well to the shape of the underlying seating surface of the cushion when a person sits on the bicycle seat, such that an efficient heat transfer between the cushion and the bicycle rider is achieved.

Also, it brings the further advantage that the sheet material better retracts from said recesses when a person leaves the seat. Thus, the portions of elastic sheet material are less likely to bulge into the recesses of the cushion when nobody is seated on the device, wherein dirt and rain water are less prone to get stuck at said portions of sheet material.

In one embodiment, the seat cover comprises a means for cinching the seat cover around the bicycle seat. This brings the further advantage that the heating device may be attached to substantially any shape and size of bicycle seats without requiring any attachment means mounted on the bicycle seat itself.

In another embodiment, the cinching means comprises a drawstring configured to stretch the seat cover around the bicycle seat. The drawstring provides a low-cost means for achieving the cinching action and is also very quick to tension and release. Further, the drawstring is very small and flexible and thus reduces the risk of chafing.

In yet an embodiment, the cinching means comprises a skirt of flexible sheet material extending from the seating portion of the seat cover and being arranged to circumscribe the perimeter of the bicycle seat. According to this embodiment, the drawstring is guided at the free edge of the skirt such that the skirt is cinched around the bicycle seat by upon tensioning of the drawstring.

This arrangement of skirt and drawstring makes it possible to tension the seating portion of the seat cover from many directions around the bicycle seat, such that wrinkles are avoided at said seating portion and such that retraction of the one or more portions of sheet material from the one or more recesses is promoted.

According to an embodiment, the flexible sheet material of the skirt is elastic. This brings the further advantage that when cinched around the bicycle seat, the skirt conforms well to the shape of the cushion and the bicycle seat, and does so with a minimum of wrinkles, thereby avoiding chafing of the person riding the bicycle.

In yet an embodiment, the heating cushion contains a material suitable for microwave heating. This brings the advantage that the cushion may be quickly heated using a commonly available microwave oven.

According to a further embodiment, the material suitable for microwave heating is an elastomer. This brings the advantage that the shape of the cushion is substantially persistent even after repeated use/deformation and thus make it possible to better control the shape and position of said one or more recesses of the cushion.

In one embodiment, the material suitable for microwave heating is a granular material. This brings the advantage in that the shape of the cushion conforms well to any shape of commonly available bicycle seat, even when a person is not seated on the cushion.

In an embodiment, the cushion comprises two interposed layers of sheet material joined around a flange such that a bag is formed. The bag is filled with a microwave-heatable material and the two layers of sheet material are joined at portions for defining said one or more recesses. This design is inexpensive to manufacture and does not require expensive custom machinery.

According to an embodiment, the granular material is flax seed. Flax seed is organic and environmentally friendly. Further, the seed may be heated over and over again without evaporation of the liquid from the seed, since the liquid is oil rather than water. Thus, the energy holding capacity of the cushion is substantially constant over time.

In a further embodiment, the two layers of sheet material are joined at portions for defining said one or more recesses by means of at least a plurality of elongate seams or welds. The elongate seams or welds join the interposed layers such that stress in material around the seams is spread evenly along the length of the seams or weld, thereby reducing the risk of material failure of the bag.

Also, in an embodiment, the seat cover comprises a membrane of heat insulating sheet material configured to be interposed between the cushion and the bicycle seat. The membrane prevents heat exchange between the cushion and the bicycle seat such that a larger amount of heat energy is available for transfer to the person riding the bike rather than into the bicycle saddle.

In one embodiment, the membrane is attached to the seat cover such that a pocket is formed for removably holding the cushion. This provides an inexpensive way to hold the cushion in a predetermined position relative to the rest of the seat cover, whilst at the same time allowing the cushion to be removed from the seat cover and subsequently reintroduced into the pocket. This in turn allows the cushion to be separately heated, for example in microwave oven in which food is usually cooked, wherein it would not be hygienic to place the seat cover in the oven. Also, the removability allows the seat cover to be separately washed, which in turn means that the cushion does not have to be washable, wherein it may be made less expensive.

According to a further embodiment, said pocket comprises an opening. The opening and the seat cover are configured such that a portion of the seat cover normally covers the opening such that the cushion cannot fall out. This provides a convenient and inexpensive way to prevent the cushion from accidentally falling out of the seat cover.

Advantageous embodiments are set forth in the dependent claims.

### DESCRIPTION OF DRAWINGS

In the following, an embodiment of the invention will be described with reference to non-limiting examples shown in the accompanying drawings, in which:

FIG. 1 is a perspective view from above showing a bicycle seat cover according to an embodiment of the invention;

FIG. 2 is a perspective view from above showing a heating cushion according to an embodiment of the invention;

FIG. 3 is a bottom view showing a bicycle seat cover according to an embodiment of the invention with its drawstring tightened;

FIG. 4 is a top view of the heating cushion also shown in FIG. 2;

FIG. 5 is a side view of cross section A-A (see FIG. 7) of a heating device according to an embodiment of the invention when attached to a bicycle seat;

FIG. 6 is a back view of the heating cushion also shown in FIGS. 2 and 4;

FIG. 7 is a top view of the heating device also shown in FIG. 5; and

FIG. 8 is a back view of cross section B-B (see FIG. 7) of the heating device also shown in FIGS. 5 and 7.

### DETAILED DESCRIPTION

Heating Device

A heating device according to the invention is primarily intended for use with conventional bicycle seats.

The heating device according to the invention has two main components, namely a heating cushion 20 and a seat cover 10 configured to hold the cushion 20 on top of the seating surface of a bicycle seat S.

When a bicycle rider is to go for a bike ride in a cold climate and wants to get some extra heat on the bicycle seat he/she just warms up the cushion in advance by use of any customary source of heat, for example by putting it in a microwave oven or standard oven, where after he attaches the heating device to a bicycle seat to provide a comfortably heated seating surface.

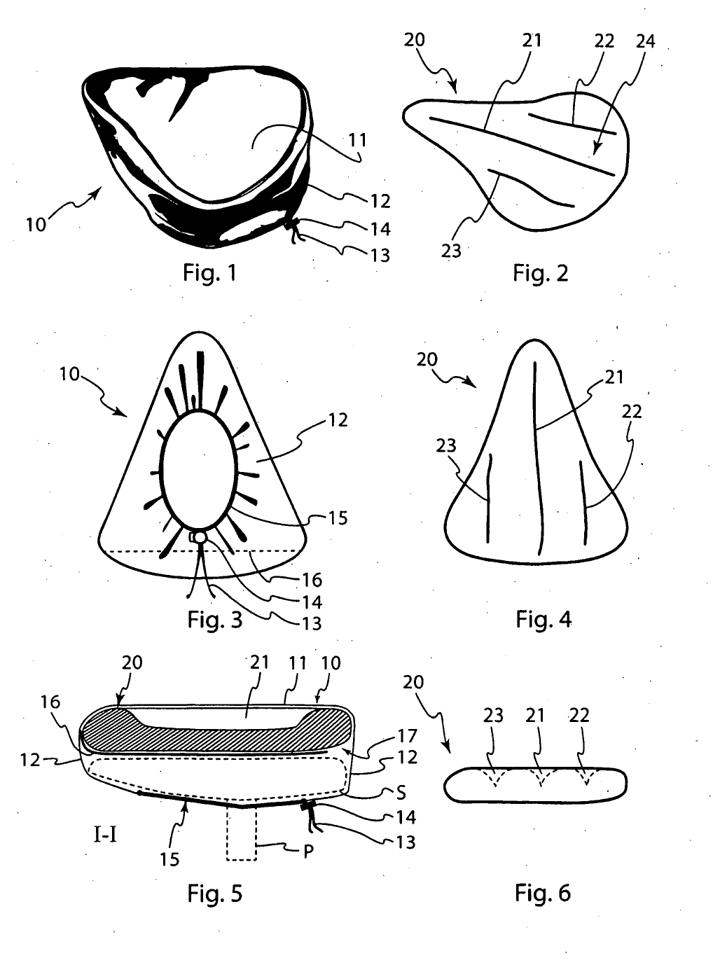

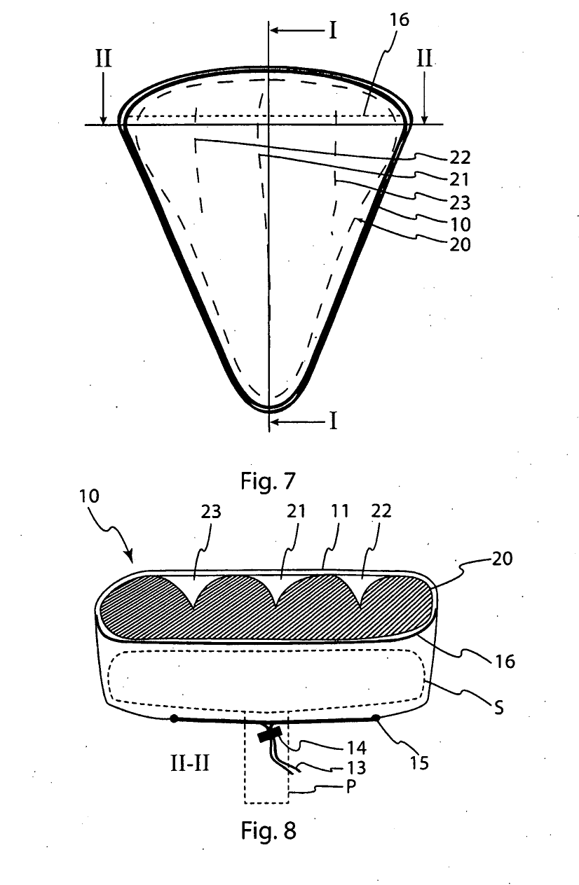

FIGS. 1-8 all relate to a first embodiment of the invention.

Seat Cover

As shown in FIGS. 1, 5, 7 and 8, the seat cover 10 is shaped to be fitted over and around a heating cushion 20 and a bicycle seat S on which the heating cushion 20 is placed. The seat cover 10 has an upper seating portion 11 generally shaped to cover the seating surface of the bicycle seat S, and cinching means configured to releasably cinch the seat cover 10 to/around the bicycle seat S.

Cinching Means

The cinching means could be any suitable cinching means. According to the first embodiment of the invention, the cinching means comprises a skirt 12 of flexible sheet material, such as textile or neoprene, extending from the circumference of the seating portion 11 such that it can be wrapped around the bicycle seat S. The cinching means further comprises a drawstring 13 movably attached to the skirt 12 along the free edge of the skirt 12 by means of a pocket 15 arranged along the free edge of the skirt 12 through which the drawstring 13 passes. The drawstring 13 is arranged such that by pulling the drawstring 13, the free edge of the skirt 12 can be contracted around the bicycle seat S to thereby cinch the heating device to the bicycle seat S. Once the cinching means 12 is tightened, it may be secured by means of a locking mechanism 14 operatively connected to the drawstring 13, thereby preventing accidental release of the heating device from the bicycle seat S.

Heating Cushion

With reference to FIGS. 2, 4, 5, 6 and 8, the heating cushion 20 generally has the shape of the seating surface of a conventional bicycle seat. Further, the heating cushion 20 is provided with recesses 21, 22, 23 in its seating surface 24, as indicated by lines in FIGS. 2, 4 and 7. Inherently, the recesses 21, 22, 23 are surrounded by ridges, or the like, of the cushion (as shown in FIGS. 5 and 6), thereby providing supporting surfaces for the seat cover 10 to rest on top of when nobody is seated on the bicycle seat S.

The cushion 20 comprises two interposed layers of sheet material joined around a flange such that a bag is formed. The bag is filled with a microwave-heatable material, such as flax seed, and the two layers of sheet material are joined at portions for defining said one or more recesses 21, 22, 23.

In an alternative embodiment, the heating cushion 20 may be made from a suitable elastomer which is either monolithic or filled with a suitable microwave heatable material.

Prolonged Heating Effect

The seating portion 11 of the seat cover 10, or at least one or more portions of it, is made from a flexible sheet material and is configured to cover said one or more recesses 21, 22, 23 such that cavities are formed between the cushion 20 and the seating portion 11 of the seat cover 10 when the heating device is attached to the bicycle seat S. The cavities provide a means for giving a prolonged heating effect of the heating device by temporarily isolating portions of the seat cover 10 from portions of the heating cushion 20 when nobody is seated on the heating device. That is, temporarily, less direct heat transfer occurs between the seat cover 10 and the heating cushion 20 by said cavities when nobody is seated.

Further Features

According to the first embodiment, as shown in FIGS. 3, 5, 7 and 8, the seat cover comprises a membrane 16 of heat insulating sheet material configured to be interposed between the cushion 20 and the bicycle seat. The membrane 16 prevents heat exchange between the cushion 20 and the bicycle seat S such that a larger amount of heat energy is available for transfer to the person riding the bike rather than into the bicycle saddle S. Hence, the membrane 16 provides a means for preventing a cold bicycle saddle from exchanging heat with the heating cushion 20. As shown, said membrane 16 is attached to the seat cover 10 such that a pocket is formed for removably holding the heating cushion 20. In the first embodiment, the membrane 16 is a neoprene sheet attached to the seat cover 10 by the same seam as the seam joining the seating portion of the seat cover and the skirt 12. As shown in FIG. 5, a portion of an edge of the membrane 16 is free such that an opening 17 for removably receiving the heating cushion 20 is formed between the membrane 16 and the seating portion 11 of the seat cover 10. Preferably, the opening 17 and the seat cover are configured such that a portion of the seat cover normally covers the opening 17, wherein the cushion is prevented from accidentally falling out.

1. A heating device for attachment to a bicycle seat, said device comprising
a heating cushion having a seating surface, and
a seat cover configured to hold the cushion on top of the seating surface of the bicycle seat,
wherein the cushion is provided with one or more recesses in its seating surface, and
wherein the seat cover comprises one or more portions of flexible sheet material configured to cover said recesses such that one or more cavities are formed between the one or more portions of flexible sheet material and the cushion.

2. A device according to claim 1, wherein the flexible sheet material is elastic.

3. A device according to claim 1, wherein the seat cover comprises a means for cinching the seat cover around the bicycle seat.

4. A device according to claim, wherein the cinching means comprises a drawstring configured to cinch the seat cover around the bicycle seat.

5. A device according to claim 4, wherein the seat cover comprises a skirt of flexible sheet material extending from a seating portion of the seat cover and being arranged to circumscribe the perimeter of the bicycle seat, said drawstring being guided at the free edge of the skirt such that the skirt is cinched around the bicycle seat by upon tensioning of the drawstring.

6. A device according to claim 5, where the skirt is elastic.

7. A device according to claim 1, wherein the heating cushion contains a material suitable for microwave heating.

8. A device according to claim 7, wherein the material suitable for microwave heating is an elastomer.

9. A device according to claim 7, wherein the material suitable for microwave heating is a granular material.

10. A device according to claim 9, wherein the granular material is flax seed.

11. A device according to claim 1, wherein the cushion comprises two interposed layers of sheet material joined around a flange such that a bag is formed, wherein the bag is filled with a microwave-heatable material and wherein the two layers of sheet material are joined at portions for defining said one or more recesses.

12. A device according to claim 11, wherein the two layers of sheet material are joined at portions for defining said one or more recesses by means of at least a plurality of elongate seams or welds.

13. A device according to claim 1, wherein the seat cover comprises a membrane of heat insulating sheet material configured to be interposed between the cushion and the bicycle seat.

14. A device according to claim 13, wherein said membrane is attached to the seat cover such that a pocket is formed for removably holding the cushion.

15. A device according to claim 14, wherein said pocket comprises an opening, and wherein the opening and the seat cover are configured such that a portion of the seat cover normally covers the opening such that the cushion cannot fall out.
